(19) United States
(12) Patent Application Publication
(10) Pub. No.: US 2008/0029339 A1
(43) Pub. Date: Feb. 7, 2008

(54) Two-Sided Step Ladder With Offset Rungs

(76) Inventor: Edward H. Yewer, Hartland, WI (US)

Correspondence Address: QUARLES & BRADY LLP, 411 E. WISCONSIN AVENUE, SUITE 2040, MILWAUKEE, WI, 53202-4497, US

(21) Appl. No.: 11/831,499

(22) Filed: Jul. 31, 2007

Related U.S. Application Data
(60) Provisional application No. 60/821,067, filed on Aug. 1, 2006.

(51) Int. Cl. E06C 1/18

(52) U.S. Cl. 182/104

(57) ABSTRACT

A two-sided step ladder having at least one rung on one side of the ladder at a different height than any of the rungs on the other side of the ladder.

### CROSS-REFERENCE TO RELATED APPLICATIONS

This application claims the benefit of U.S. Provisional Patent Application No. 60/821,067 filed Aug. 1, 2006.

### STATEMENT REGARDING FEDERALLY SPONSORED RESEARCH OR DEVELOPMENT

Not applicable.

### FIELD OF INVENTION

The present invention relates generally to step ladders and, more particularly, to two-sided step ladders having rungs on both sides.

### BACKGROUND OF THE INVENTION

Step ladders are well-known. People employ step ladders in numerous tasks that require them to work at an otherwise unreachable height. A user configures the orientation of a ladder, ascends a plurality of ladder rungs to a desired height, and performs a task. Common tasks requiring the use of a step ladder include painting, construction, and repair.

In prior step ladders, the user only had a limited number of rung heights on which to stand when using the ladder. Having only a limited number of rung heights created a problem because the user could be either too high or too low on a given rung to work comfortably.

### BRIEF SUMMARY OF THE INVENTION

The present invention solves the problems associated with achieving a comfortable rung height by providing a two-sided step ladder with offset rungs. On each side of the ladder, a set of rungs connects the two legs on that side. The rungs on a given side of the ladder are spaced apart, generally horizontal and parallel to one another when the ladder is in the use position. However, at least one of the rungs on one side of the ladder is located at a different height than any rung on the other side of the ladder.

These and other features and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a two-sided step ladder of the invention with offset rungs in a use position, in which the rungs on one side of the ladder are offset relative to the rungs on the other side of the ladder by half of the distance between the rungs; and

FIG. 2 is a cross-sectional view taken along line 2-2 of FIG. 1 showing the embodiment of FIG. 1.

### DETAILED DESCRIPTION OF THE PREFERRED EMBODIMENT

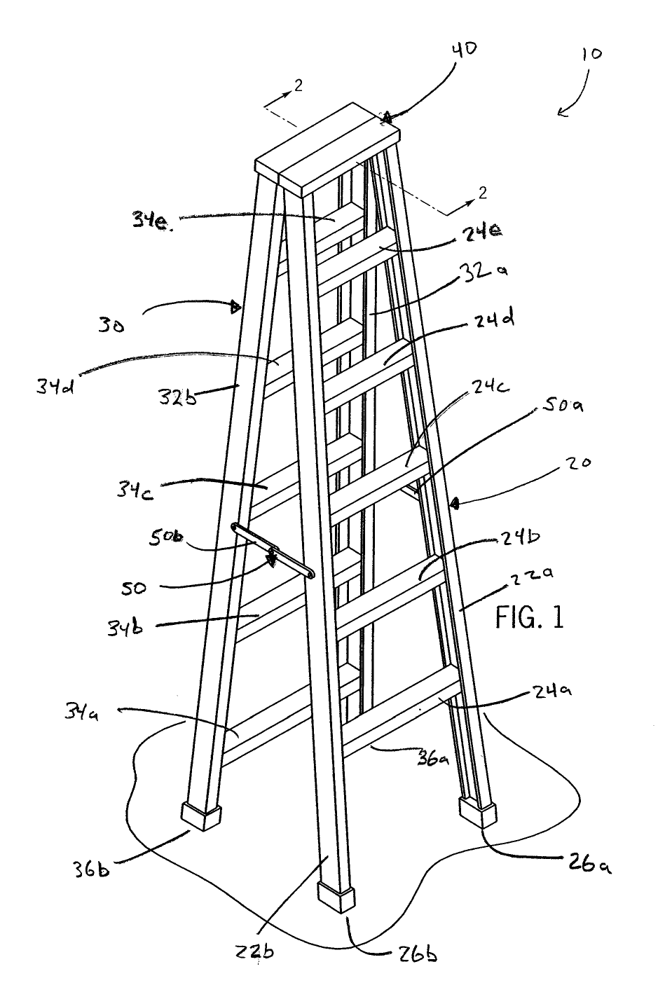

FIG. 1 illustrates a ladder 10 having a first side 20 and a second side 30 connected at a top platform 40 and secured when in the use position by a pair of spreaders 50. The ladder 10 is positioned in a use position, such that a user might be able to safely ascend the ladder 10 to perform a task.

The first side 20 includes a pair of legs 22, a set of rungs 24, and a pair of feet 26. The pair of legs 22 includes a first leg 22a and a second leg 22b which are connected by the set of rungs 24. The rungs 24 include a bottom rung 24a, intermediate rungs 24b-24d, and a top rung 24e. The pair of feet 26 includes a first foot 26a, which is attached to the bottom of the first leg 22a, and a second foot 26b, which is attached to the bottom of the second leg 22b.

The second side 30 includes a pair of legs 32, a set of rungs 34, and a pair of feet 36. The pair of legs 32 includes a first leg 32a and a second leg 32b which are connected by the set of rungs 34. The rungs 34 include a bottom rung 34a, intermediate rung 34b-34d, and a top rung 34e. The pair of feet 36 includes a first foot 36a, which is attached to the bottom of the first leg 32a, and a second foot 36b which is attached to the bottom of the second leg 32b.

The user ascends the ladder 10 by climbing one of the sets of rungs 24 or 34. The term “rung” as used in this patent application is defined to be a generally horizontal surface which is designed to be stood on by the user of the ladder when the ladder is in the use position. Ladder components which are purely structural and were not designed to be stood on by the user of the ladder are not rungs. Thus, the top rungs 24e and 34e are the topmost rungs on the ladder 10 because the top platform 40 is not designed to be stood on safely.

The pairs of feet 26 and 36 provide points of contact between the ladder 10 and the surface the ladder is placed on.

The top platform 40 connects the first side 20 and the second side 30. However, the top platform 40 is not required to practice the present invention and should not be considered to be a limitation. The first side 20 and the second side 30 could be directly attached to each other without the top platform 40, although the top platform 40 may provide a flat surface to place objects, such as tools or paint cans, that the user of the ladder may need in performing the task.

It should be appreciated that the connection between the first side 20 and the second side 30, whether by the top platform 40 or by directly connecting the first side 20 and the second side 30, might permit the first side 20 to pivot or move relative to the second side 30. For example, if the ladder 10 is designed similar to a traditional foldable ladder, one side 20 would be able to pivot relative to the second side 30. Additionally, the connections between the first and second sides 20 and 30 and the top platform 40 might permit both, neither, or only one of the first side 20 and the second side 30 to pivot relative to the top platform 40.

The pair of spreaders 50 includes a first spreader 50a and a second spreader 50b. The first spreader 50a pivotally attaches to both the first leg 22a of the first side 20 and the first leg 32a of the second side 30. The second spreader 50b pivotally attaches to both the second leg 22b of the first side 20 and the second leg 32b of the second side 30. The pair of spreaders 50 act in concert if the ladder is opening or closing. However, the pair of spreaders 50 is not required of the present invention and should not be considered to be a limitation.

It should be appreciated that if the first side 20 and the second side 30 are capable of pivoting relative to one another, the pair of spreaders 50 may restrict the range of pivoting motion. This restriction prevents the ladder 10 from spreading any further open than the pair of spreaders 50 will allow when the ladder 10 is in a use position. The pair of spreaders 50 may be foldable, such that when the ladder is collapsed, the pair of spreaders 50 is folded, and when the ladder is in a use position, the pair of spreaders 50 is extended. One possible type of foldable spreader would be a two-bar link.

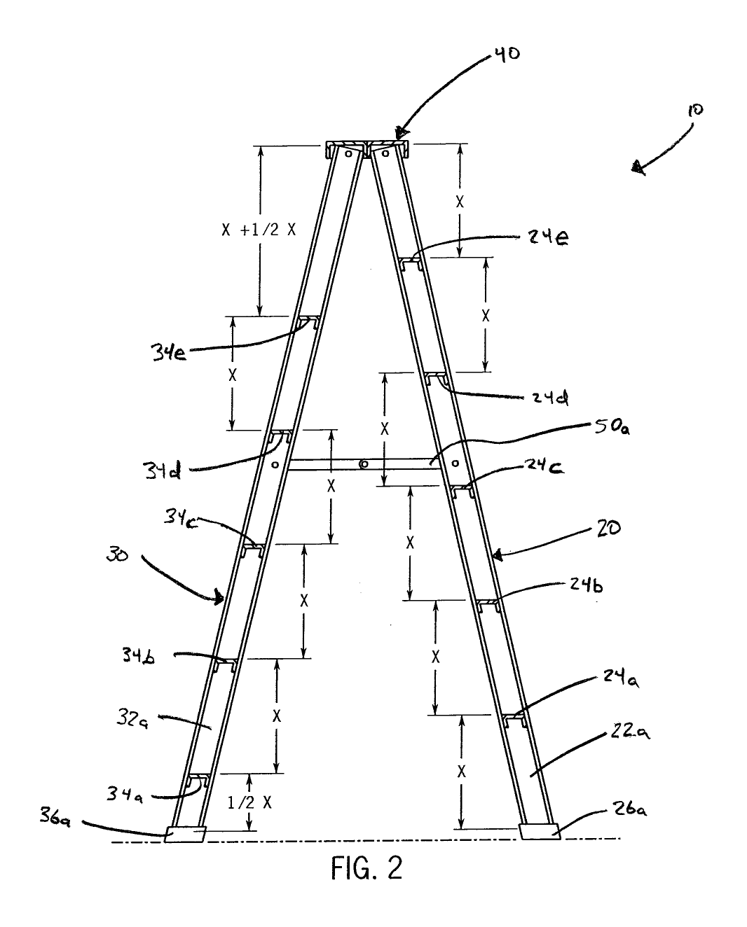

FIG. 2 provides a cross-sectional view of the ladder 10 along plane 2-2 of FIG. 1. Both the first set of rungs 24 and the second set of rungs 34 have a perpendicular rung-to-rung distance X. The term “perpendicular” will be used to indicate the vertical distance normal from the surface that the ladder 10 rests on when the ladder 10 is in the use position. On the first side 20, the perpendicular distance between the bottom rung 24a and the set of feet 26 is equal to the perpendicular rung-to-rung distance X. Likewise, the perpendicular distance between the top rung 24e and the top platform is also equal to the rung-to-rung distance X. However, on the second side 30, the perpendicular distance between the bottom rung 34a and the set of feet 36 is only one-half of the perpendicular rung-to-rung distance X. Because the same quantity of rungs are present on the first side 20 and the second side 30, and the first side 20 and the second side 30 are of equal length, the perpendicular distance from the top rung 34e to the top platform 40 is equal to one and one-half the perpendicular rung-to-rung distance X. Thus, although the ladder 10 only has a single perpendicular rung-to-rung distance X, the available rung heights are available in increments of one-half the perpendicular rung-to-rung distance X.

It should be appreciated that while FIG. 2 shows a ladder 10 with a regular perpendicular rung-to-rung distance of X, that each set of rungs may be regularly or irregularly spaced and may be similar or dissimilar to the spacing pattern found on the other set of rungs. For example, the rungs on the first side may be regularly spaced at a rung-to-rung distance of 12 inches while the rungs on the second side may be regularly spaced at a rung-to-rung distance of 16 inches. Moreover, the rungs on one or both sides may be irregularly spaced. For example, the rungs on one side of the ladder may get closer near the top of the ladder.

It should be further appreciated that the first set of rungs 24 and the second set of rungs 34, do not need to contain the same quantity of rungs. For example, in the case in which the rungs on one side of the ladder are spaced 12 inches apart and the rungs on the other side of the ladder are spaced 16 inches apart, if each side of the ladder is 8 feet long, it is possible that the side of the ladder with rungs spaced 12 inches apart will have 7 or 8 rungs and the side of the ladder with rungs spaced 18 inches apart will have 5 or 6 rungs. Moreover, both sides of the ladder might not be the same length as might be the case if the ladder leg lengths are adjustable, if the ladder is designed such that one side of the ladder rests on a surface at a different height than the other side of the ladder, or if the ladder is simply designed to have different lengths on each side.

It is specifically intended that the present invention not be limited to the embodiments and illustrations contained herein, but include modified forms of those embodiments including portions of the embodiments and combinations of elements of different embodiments as come within the scope of the following claims.

I claim:

1. In a two-sided step ladder including two sides, each side having a pair of legs and a set of rungs, each pair of legs being spaced apart and generally parallel to one another, the rungs of each set being parallel and spaced apart from one another, the rungs connecting each pair of legs and being generally horizontal when the ladder is in a use position, the two sides being connected to one another at a top end of the ladder, an improvement wherein:
a height of at least one of the rungs of one of the sets of rungs is offset from a height of all of the other rungs of the other set of rungs when the ladder is in the use position.

2. The two-sided step ladder of claim 1, wherein the two sides are connected at the top by a pivot connection.

3. The two-sided step ladder of claim 2, further comprising a pair of foldable spreaders, each spreader being pivotally attached between a leg of one side of the ladder and a leg of the other side of the ladder.

4. The two-sided step ladder of claim 3, wherein the pair of foldable spreaders restricts a range of pivoting motion of the sides of the ladder.

5. The two-sided step ladder of claim 3, wherein each of the foldable spreaders is a two-bar link.

6. The two-sided step ladder of claim 2, wherein both the top of one side of the ladder and the top of the other side of the ladder is connected to a platform at two pivot joints.

7. The two-sided step ladder of claim 1, wherein a spacing between the rungs on one side of the ladder is equal to a spacing between the rungs on the other side of the ladder.

8. The two-sided step ladder of claim 7, wherein the height from a bottom rung on one side of the ladder to a bottom end of that side is equal to twice the height from a bottom rung on the other side of the ladder to a bottom end of the other side.

9. The two-sided step ladder of claim 1, wherein a spacing between one set of rungs is different than a spacing between the other set of rungs.

10. The two-sided step ladder of claim 1, wherein one set of rungs contains a different quantity of rungs than the other set of rungs.

11. The two-sided step ladder of claim 1, wherein the sides of the ladder are of equal length.

12. The two-sided step ladder of claim 1, wherein the sides of the ladder have different lengths.
